(19) United States
(12) Patent Application Publication
(10) Pub. No.: US 2018/0114237 A1
(43) Pub. Date: Apr. 26, 2018

(54) SYSTEM AND METHOD FOR COLLECTING ONLINE SURVEY INFORMATION

(71) Applicants: Peter Kirk, New York, NY (US); Osnat Benshoshan, New York, NY (US); Douglas P. Fields, JR., Brooklyn, NY (US)

(72) Inventors: Peter Kirk, New York, NY (US); Osnat Benshoshan, New York, NY (US); Douglas P. Fields, JR., Brooklyn, NY (US)

(21) Appl. No.: 15/791,032

(22) Filed: Oct. 23, 2017

Related U.S. Application Data
(60) Provisional application No. 62/411,496, filed on Oct. 21, 2016.

(51) Int. Cl. G06Q 30/02; G06Q 50/00; G06F 3/0482; H04L 29/08; H04L 29/06; H04L 9/32

(52) U.S. Cl. CPC G06Q 30/0203; G06Q 50/01; H04L 9/3213; H04L 67/10; H04L 63/0407; G06F 3/0482

(57) ABSTRACT

A system and associated interfaces are provided that facilitate Internet surveying and survey information collection. In one aspect, a survey engine may transition between various phases of a survey function. For example, a first phase of the survey function may allow users to provide discussion topics. A second phase of the survey function may allow users to vote on provided discussion topics. A third phase of the survey function may allow users to comment on a discussion topic that was selected based on the voting in the second phase. A fourth phase of the survey function may compile received comments and display the compiled received comments to the users. The survey engine may be adapted to automatically transition between the phases of the survey function.

### RELATED APPLICATIONS

This Application claims priority under 35 U.S.C. § 119(e) to U.S. Provisional Application Ser. No. 62/411,496, entitled “SYSTEM AND METHOD FOR COLLECTING ONLINE SURVEY INFORMATION” filed on Oct. 21, 2016, which is incorporated by reference in its entirety.

### BACKGROUND

### 1. Field of Invention

The field of the invention relates generally to Internet survey systems, and more particularly, to systems and methods for collecting survey information.

### 2. Discussion of Related Art

There are many methods for collecting survey information, especially over distributed networks such as the Internet. Types of surveys range in the information they collect and the manners in which they are presented to users.

Qualitative research is primarily exploratory research, and is used to gain an understanding of underlying reasons, opinions, and motivations. Qualitative research provides insights into the problem or helps to develop ideas or hypotheses for potential quantitative research. Qualitative Research is also used to uncover trends in thought and opinions, and dive deeper into a particular problem. Qualitative data collection methods vary using unstructured or semi-structured techniques. Some common methods include focus groups (group discussions), individual interviews, and participation/observations. The sample size is typically small, and respondents are selected to fulfill a given quota.

Quantitative research is used to quantify the problem by way of generating numerical data or data that can be transformed into useable statistics. It is used to quantify attitudes, opinions, behaviors, and other defined variables—and generalize results from a larger sample population. Quantitative research uses measurable data to formulate facts and uncover patterns in research. Quantitative data collection methods are much more structured than qualitative data collection methods and generally involve more respondents. Quantitative data collection methods include various forms of surveys—online surveys, paper surveys, mobile surveys and kiosk surveys, face-to-face interviews, telephone interviews, longitudinal studies, website interceptors, online polls, systematic observations, among others.

### SUMMARY

According to one aspect of the present invention, it is realized that improved methods for collecting survey information are needed that are more efficient and derive necessary information using less effort and steps, particularly within systems that integrate multiple respondents, such as those that operate over the Internet. However, it is appreciated that several forms of market research are different, and are not necessarily integrated. According to one aspect of the present invention, it is appreciated that it would be beneficial to provide new methods of collecting market research information. In one implementation, a new market research methodology and process is provided that combines classical quantitative market research surveys with automated qualitative research. In another implementation, this methodology may be integrated within a social networking system.

In another aspect, an output of the study includes core structured quantitative data commissioned by the an information consumer (e.g., a client) as well as unstructured social conversation about the study or related topics. According to one aspect, the number of steps and time between performing qualitative research to quantitative research is reduced, and the result may be provided to the client in a more expedient manner. When integrated with a social network, the conversation can take place concurrently with the study as well as after the study is completed on a social network platform. Also, the study may be either closed to respondents or open to respondents and other members of the social network. This social conversation is referred to herein as social user generated content (UGC).

According to another aspect, the combination of the quantitative and automated user generated qualitative data yields a much richer and more holistic dataset. The additional value could be transformational for quantitative research. Not only is the research methodology of combining quantitative surveys with social UGC new and unique, another first is the automation of qualitative user generated research derived from a quantitative study.

According to another aspect, a unique methodology of switching from quantitative to qualitative collection methods may be implemented within an online data gathering system (e.g., a survey system), and in the process, the system maximizes the likelihood of automatically creating 100% user-generated high quality discussions related to a quantitative study.

According to one implementation, a creation of social survey information and the resulting unstructured qualitative social conversation (the movement from quantitative to qualitative mode) may include three major stages within an overall process. In a first stage, the system presents an interface that asks a group of quantitative respondents to think of and submit an interesting peer to peer discussion topic related to the quantitative study. After the system has received a certain number of discussion topics (e.g., 3-5 discussion topics) the system moves to a second stage. For instance, in an online network of a closed group of respondents, the respondents may be presented a question by the system to submit a topic of discussion in relation to hepatitis drugs (e.g., from a group of selected physicians). The respondents may be offered some offer in association with their participation (e.g., an honorarium). The system may collect the responses, and after a predetermined threshold is determined, the system proceeds to another phase of data collection.

According to another implementation, in a second stage, the system presents an interface to respondents that permits the respondents to vote on which submitted discussion topic from the first stage is best for a peer to peer discussion. For instance, the system may present each of the collected questions from the respondents in the first stage to a number of voting respondents (who may be the same respondents in the first stage) to determine a selected candidate voting topic. Once a discussion submission has a predetermined number of votes (e.g., three votes or more or some other configurable threshold) the system progresses to a qualitative stage for collecting survey information (e.g., at a third stage), the survey information including qualitative commentary or conversation information regarding the winning topic. It should be appreciated that one or more candidate questions may be voted through and submitted for feedback in the third stage. In one implementation, a single question of the candidate questions is selected.

In one implementation, at a third stage, the system collects comments, from subsequent respondents, to a discussion regarding the winning topic determined by the second stage. Once the system compiles a predetermined number of comments (e.g., 30 comments on the topic), the system transitions to the first stage to create a new discussion by subsequent respondents. According to one implementation, the system automatically rotates through the stages, eliminating human intervention in the collection process. Further, because the process is automated, any number and type of survey can be generated (even in parallel) to produce quantitative and qualitative information.

As an alternative implementation, the conversation can occur and be collected either off the social platform or on the social platform. When the conversation is performed and collected on the social network, non-survey respondents may be requested to participate within the conversation. For instance, a closed survey group consisting of certain targeted doctors may be requested to establish and vote for the qualitative portion in the first two stages, and the survey information may be collected from a number of respondents outside of the initial survey group. Such a survey may be posted, for example, to an open or closed social networking group.

Within a specific social networking group such as the well-known SERMO physician online community, one or more of the aspects for collecting survey information may address the limitations of traditional quantitative data collection in healthcare:
Conventional quantitative surveys are one-directional and force respondents to answer within a fixed structure
Real-world medicine is often complicated and always nuanced
Responses to healthcare surveys often miss the type of subtleties found in qualitative research

According to one embodiment of the present invention, a system is provided for collecting survey information. For instance, the system may be implemented using one or more components and interfaces that allows multiple respondents to provide information which is then aggregated and provided to information consumers. According to one embodiment, the collection of candidate questions for the survey, election of winning questions, and collection of survey responses for the winning questions are all performed automatically by the system. According to one implementation, system is capable of automatically generating survey questions and responses in real time responsive to provided targeted areas that are created by a client.

According to another implementation, the survey system is coupled to a social networking system, and the survey system is adapted to submit entries as posts within the social network which can be used to generate further high-value content. Further, the system may connect to other systems and provide additional functionality, such as sending emails to non-winning respondents and requesting feedback on winning entries.

Further, the system may collect a variety of information in particular topic areas, such as those areas requested by a client, and the client may be presented an interface in which to view results from surveys in progress (e.g., by a client portal). In one version of the client portal, a client may be permitted to put forth a topic as if it had been a winning topic, and may submit the topic for comments to the network. In another aspect, it is appreciated that during different forms of market research, the clients do not have access to respondents, so according to one implementation, the system may include a capability for the client to correspond or otherwise contact a respondent (e.g., anonymously) based on information within the survey results. For example, a client may want to follow-up on a certain issue within an anonymized physician network on a particular issue, and the physician may be offered an honorarium to do so. In one implementation, the system permits both the client and the respondent to be anonymous to each other within this communication.

According to one aspect, a distributed system is provided comprising a survey engine adapted to perform a plurality of survey functions in a computer system controlling a survey including one or more functions that generate a plurality of first stage interfaces, each of the plurality of first stage interfaces being generated for respective ones of a plurality of respondents; receive, via the plurality of first stage interface, respective topics from one or more of the respondents, each of the respective topics being authored by the respective respondent; generate a plurality of second stage interfaces, each of the plurality of second stage interfaces being generated for respective ones of the plurality of respondents; receive, via the plurality of second stage interfaces, a respective vote for one or more of the received topics; automatically determine, responsive to the received plurality of votes, at least one winning topic of the respective topic received from the respective respondents; generate a plurality of third stage interfaces, each of the plurality of third stage interfaces being associated with the plurality of respondents and having controls to accept user feedback regarding the at least one winning topic of the respective topics received from the respective respondents.

According to one embodiment, the survey engine is adapted to automatically compile the received user feedback into compiled information and display the compiled information to a client via a fourth stage interface. According to another embodiment, the survey engine is adapted to indicate, to the plurality of respondents, the at least one winning topic responsive to the determining of the at least one winning topic.

In another embodiment, the survey engine is adapted to perform the plurality of survey functions without operator intervention. According to another embodiment, the survey engine is operable to submit the compiled information as a post to a social network.

According to another embodiment, the distributed system further comprises a component adapted to collect feedback received from the social network relating to the post, and providing the feedback automatically to the client. In yet another embodiment, the distributed system further comprises a router component adapted to transition a respondent through a set of first, second and third stage interfaces.

In another embodiment, the router component is adapted to perform a validation of a user token associated with a respondent. In yet another embodiment, the router component is adapted to perform a check of a particular project survey prior to admittance of the user to the project survey. In another embodiment, the router component is adapted to perform a check of a particular member prior to admittance of the user to a project survey.

In yet another embodiment, the router component is adapted to perform a check of a particular member/project combination prior to admittance of the user to a project survey. In one embodiment, the distributed system further comprises a router component adapted to transition a respondent to a particular survey based on one or more parameters relating to a user. In another embodiment, the distributed system further comprises a router component adapted to evaluate one or more parameters relating to a state of a survey and execute a transition between the set of first, second and third stage interfaces responsive to the evaluation of the one or more parameters.

In another embodiment, the distributed system further comprises a router component adapted to evaluate a member and/or a project responsive to exclusion/inclusion logic defining whether to admit a user to a specified survey. In another embodiment, the evaluation and transition is performed in real time in parallel for a plurality of surveys.

In another embodiment, the distributed system further comprises a router component adapted to transition the user to an egress state of a browser program. In another embodiment, the router component is adapted to record a plurality of ingress and egress states associated with a particular user and project.

In another embodiment, the survey engine is adapted to permit an anonymous bidirectional communication between a client that sponsors the survey and at least one of the plurality of respondents. In another embodiment, the survey engine is adapted to award an honorarium to the at least one of the plurality of respondents for opting into the bidirectional communication.

In another embodiment, the survey engine is adapted to receive a fee from the client to initiate the anonymous bidirectional communication. In another embodiment, the survey engine is adapted to generate a client interface in which a client is permitted to submit a seed topic to which the respective topics are submitted from one or more of the respondents. In another embodiment, the survey engine is adapted to generate an input within the client interface that permits the client to submit a winning topic, and responsive to the submission of the winning topic, the survey engine is adapted to bypass the first stage and second stage receiving stages.

In another embodiment, the survey engine is adapted to generate a client interface including a plurality of ingress controls that determine which respondents are admitted to participate in the survey.

In another embodiment, the survey engine is adapted to generate a client interface including a plurality of controls that permit the client to define participation rules for conducting the survey. In another embodiment, the plurality of controls includes at least one control that limits the survey to respondents within a social network.

Still other aspects, examples, and advantages of these exemplary aspects and examples, are discussed in detail below. Moreover, it is to be understood that both the foregoing information and the following detailed description are merely illustrative examples of various aspects and examples, and are intended to provide an overview or framework for understanding the nature and character of the claimed aspects and examples. Any example disclosed herein may be combined with any other example in any manner consistent with at least one of the objects, aims, and needs disclosed herein, and references to “an example,” “some examples,” “an alternate example,” “various examples,” “one example,” “at least one example,” “this and other examples” or the like are not necessarily mutually exclusive and are intended to indicate that a particular feature, structure, or characteristic described in connection with the example may be included in at least one example. The appearances of such terms herein are not necessarily all referring to the same example.

### BRIEF DESCRIPTION OF DRAWINGS

Various aspects of at least one example are discussed below with reference to the accompanying figures, which are not intended to be drawn to scale. The figures are included to provide an illustration and a further understanding of the various aspects and examples, and are incorporated in and constitute a part of this specification, but are not intended as a definition of the limits of a particular example. The drawings, together with the remainder of the specification, serve to explain principles and operations of the described and claimed aspects and examples. In the figures, each identical or nearly identical component that is illustrated in various figures is represented by a like numeral. For purposes of clarity, not every component may be labeled in every figure. In the figures:

FIG. 1 shows a block diagram of a system according to one embodiment of the present invention;

FIG. 2 shows a process for conducting a survey in accordance with one embodiment of the present invention;

FIG. 3 shows one embodiment of a router component and survey process according to various embodiments;

FIG. 4 shows a block diagram of data structures used in various embodiments;

FIG. 5 shows another embodiment of a router component according to various embodiments;

FIG. 6 shows an example user interface for a first stage of a survey function generated by a survey engine according to various embodiments;

FIG. 7 shows an example user interface for a second stage of a survey function generated by a survey engine according to various embodiments;

FIG. 8 shows an example user interface for a third stage of a survey function generated by a survey engine according to various embodiments; and

FIG. 9 shows another example user interface for a third stage of a survey function generated by a survey engine according to various embodiments.

### DETAILED DESCRIPTION

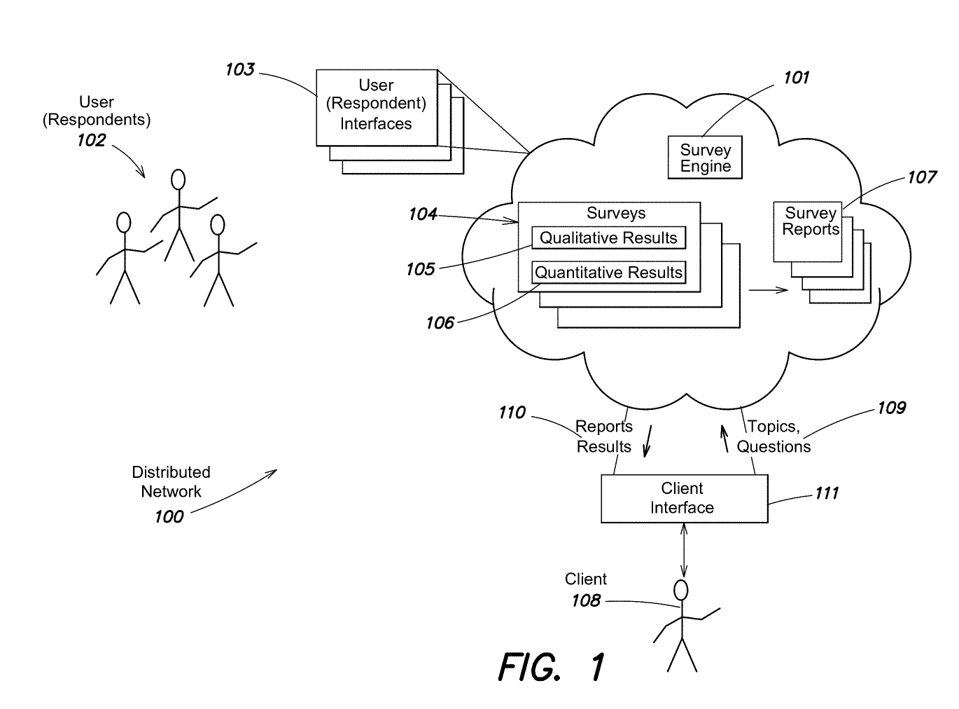

FIG. 1 shows one embodiment including a block diagram of a system according to one embodiment of the present invention. In particular, FIG. 1 shows a distributed network 100 that includes a number of distributed computer systems coupled by one or more communication networks. In particular, one or more users (respondents) 102 interact with one or more user (respondent) interfaces 103 presented as part of a distributed survey system.

The survey system may include a survey engine 101 that functions to perform surveys with multiple users/respondents (e.g., users/respondents 102). According to one aspect, survey engine 101 is capable of automatically conducting one or more surveys (e.g. surveys 104) which include both qualitative and quantitative aspects. In one implementation, survey engine 101 performs a series of interactions with a group of respondents that permits both qualitative and quantitative results to be compiled for one or more topics. The survey engine 101 may be implemented as, for example, a software component stored in a non-transitory computer-readable medium that is executed by at least one hardware processor in the distributed network 100.

In one embodiment, topics and/or questions may be provided to the survey engine by the client 108. To this end, client 108 may be presented one or more client interfaces 111 which allow the client to integrate with the survey system. In one implementation, the client provides one or more topics of discussion to the survey system and the client receives one or more survey results including reports (e.g., survey reports 107) or any other results (e.g., results 110) through the client interface 111.

As discussed, survey engine 101 may be capable of automatically performing one or more surveys that collect both qualitative and quantitative results in a more efficient manner. According to one embodiment, such surveys may be generated on-the-fly, and their results may automatically spawn additional steps within the process, including but not limited to, automatically generating reports, identifying new questions for potential surveys, and submitting vetted topics to one or more groups of users (e.g., a social network).

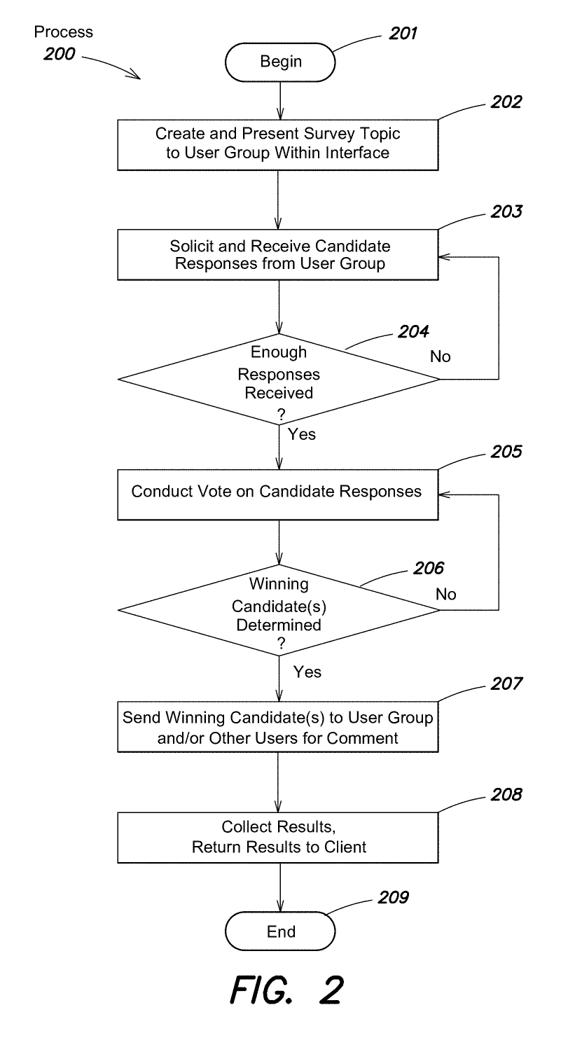

FIG. 2 shows a process for conducting a survey in accordance with one embodiment of the present invention. Such a process 200 may be performed, for example, using one or more components as discussed above with reference to FIG. 1. At block 201, process 200 begins. At block 202, the system (e.g. a survey system) creates and presents a survey topic to a user group within one or more user interfaces. For instance, responsive to a seed topic area provided by a client, the system may ask for relevant topics for discussion to be posed to the group on the identified seed topic area. One or more users may respond within the interface to provide their example topics (e.g., in the form of a comment, question, or other format) for consideration among the group of users. In this way, there may be interaction among users to define and determine a more relevant topic to collect feedback. This survey process contrasts with typical surveys which do not involve user-to-user coordination in that they are carefully defined off-line and then provided to users.

At block 203, the system solicits and receives candidate responses from the user group as discussed above. The candidate responses include candidate topics that are relevant to the topic area provided by the client. At block 204, the system determines whether there are enough responses received from the users. For example, the system may have defined a predetermined number of responses to receive prior to transitioning to a voting stage. In the case where none enough responses have been received, the system may continue to collect and solicit responses from the user group. In one embodiment, the system may automatically expand the user group based on the number of received responses (e.g., if the received responses are insufficient).

At block 205, the system conducts a vote on the candidate responses. For example, for any candidate response, users from the group may be solicited to vote for particular candidates. In one particular mentation, the number of candidate responses that are voted on may be limited by the system (e.g., the top three candidates). The vote may include responses such as yes/no, up/down, or other types of inputs (e.g., other binary inputs, other quantitative inputs). At block 206, the system may determine whether there are one or more winning candidates determined. For example, this may occur when a particular candidate response reaches a predetermined number of votes, receives a particular percentage of the vote, and/or any combination of parameters that could indicate a consensus among candidate responses.

If one or more winning candidates are determined at block 206, the system may send a winning candidate response to the user group and/or other users for comment. At block 208, the system may collect the results and return the results to the client. In one example implementation, the system may automatically correlate responses from multiple users and present a consolidated report to the client. According to one aspect, the report may include both qualitative and quantitative information. At block 209, process 200 ends.

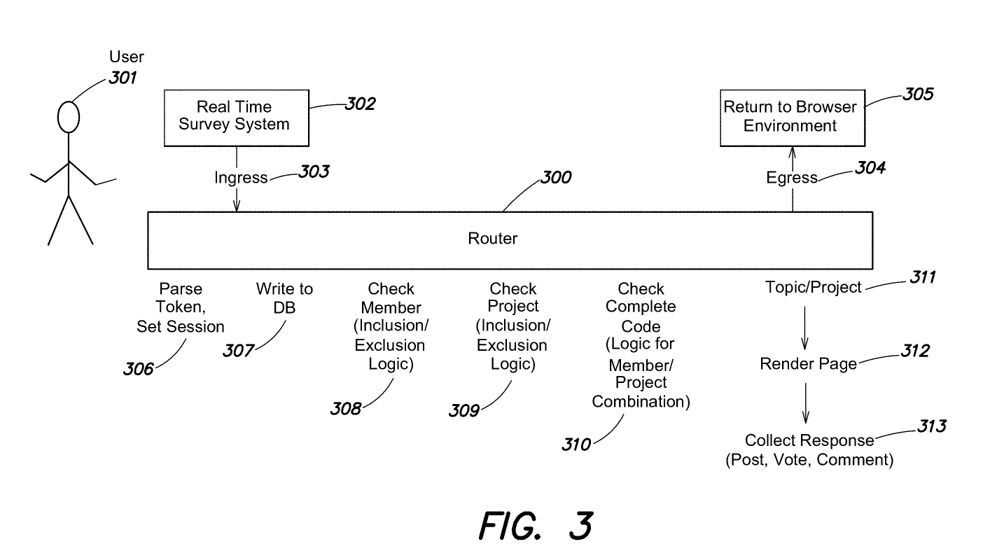

FIG. 3 shows one embodiment of a router component and survey process according to various embodiments. In particular, FIG. 3 shows a router component 300 that performs one or more functions associated with an online survey process according to various embodiments. For example, router 300 may receive one or more ingress communications from one or more external processes. For instance, another process such as one associated with the browser program executing a particular website interface may direct the user to a router (e.g., router 300) that performs a number of real time checks, and conducts surveys for appropriate users. In one example, a real-time survey system 302 passes off a particular user (e.g., user 301) to the router as a possible participant within a particular survey. The router component 300 may be implemented as, for example, a software component stored in a non-transitory computer-readable medium that is executed by at least one hardware processor in a distributed network (e.g., distributed network 100).

At an initial step 306, a token associated with the user is handed (e.g., via a communication protocol) to the router. In one particular instance, the router parses the token, checks the validity of the token, and sets a session within the router. At step 307, the router writes the session to the database, after which one or more external components may be called (e.g., via API or other interfaces). For example, at step 308, the router checks the member and parameters associated with the user (e.g., user 301). For instance, this system may maintain a separate membership database and according to one embodiment, the system may have inclusion and exclusion logic that determines whether a particular member can participate in a particular survey. For instance, in one example criteria, a survey participant must be a valid member within a particular social network (e.g., a physician in a closed physician network). To this end, router 300 may access a membership database to obtain user information that can be used to validate the user.

At step 309, the router may check project information associated with a particular survey. For instance, depending on the survey being conducted and one or more states of where that particular survey resides, the router may determine whether a particular user is admitted into the survey. For instance, the system may maintain one or more parameters (e.g., health codes, completion percentages, country of medical practice, specialty of medical practice, languages spoken, or other parameters) that evaluate the survey which can be used as admission criteria for particular users. In one example, a particular surveys may not have enough members, may not be completed within a specific timeframe, or other evaluation that would prohibit additional users to be admitted to the survey. Responsive to a failed check member at step 308 or a check project at step 309, the router may reject the user and return the user via an egress 304 back to another environment (e.g., such as returning the user's viewing context to a browser environment 305).

The system may also include a step of checking a complete code 310 which may include logic for member/project combinations. In one implementation, is appreciated that although individual member and project checks may pass, the combination of a particular member and project may not be good for the survey. For example, in one instance, a member may check out as being a possible participant in the survey, and the health of a particular project may be good, however the number of people needed to complete the survey from a particular quota group may be exceeded, and as a result, the user may be screened out from a particular survey.

If these checks clear, however, the user may be permitted to interact with the survey, including permitting the user within the user face to define a particular candidate topic (e.g., a topic/project), and thereafter a page may be rendered at step 312 to the user and other users within the survey group. The system may collect responses at step 313 including posting of candidate topics, voting, and/or comment submitted to one or more winning topics.

After the responses are completed, the survey system may collect and collate such responses and store them within the database. Such information may be presented to the client that commissioned a particular survey. The router may thereafter return the user to an egress 304 which puts the user into another context (e.g., a return to a previous browser environment) at step 305.

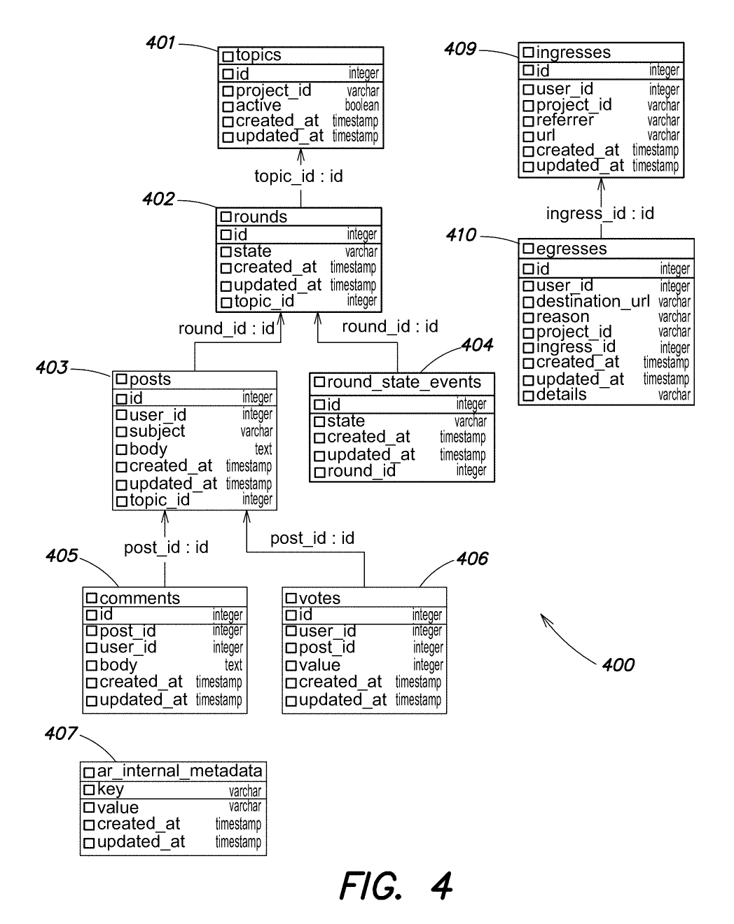

As discussed previously, the router may track any number of the ingress and egress processes for particular users, along with any results of the survey. To this end, router 300 may maintain one or more databases that identify different surveys, topics, states, comments, loading results, or any other information. FIG. 4 shows a block diagram of example data structures (e.g., data structures 400) used in various embodiments used to store state and variable information. For example, one or more topics 401 may be created in the system (e.g., by a client). The topic may have a unique project ID, and the system may track the state of the topic, when it was created, and last updated. Further, the topic may have one or more rounds (e.g., rounds 402) which tracks the state, when it is created, and a link to the particular defined topics.

When within each round, there may occur one or more posts (e.g., posts 403) received from one or more users having different user IDs and having various levels of content. The system may also track events (e.g., events 404) occurring within each round associated with each individual round specified by a round ID.

The system may be adapted to maintain other information relating to comments (e.g., comments 405), votes (e.g., votes 406), any internal metadata (e.g., ar_internal_metadata 407), etc. as needed for operating the survey system. The system may also track the particular ingress and egress information (e.g., ingresses 409, egresses 410) associated with how the user arrives within the survey and how they left the survey. Information that may be tracked can include information identifying particular ingress refers, URLs, and information identifying when the ingress occurred. Further, egress information may include when the user was transferred, what destination it was sent to, the reason for the egress, and any other egress—related information. Some of all of this information may be reported or otherwise provided to the client (e.g., within a user interface).

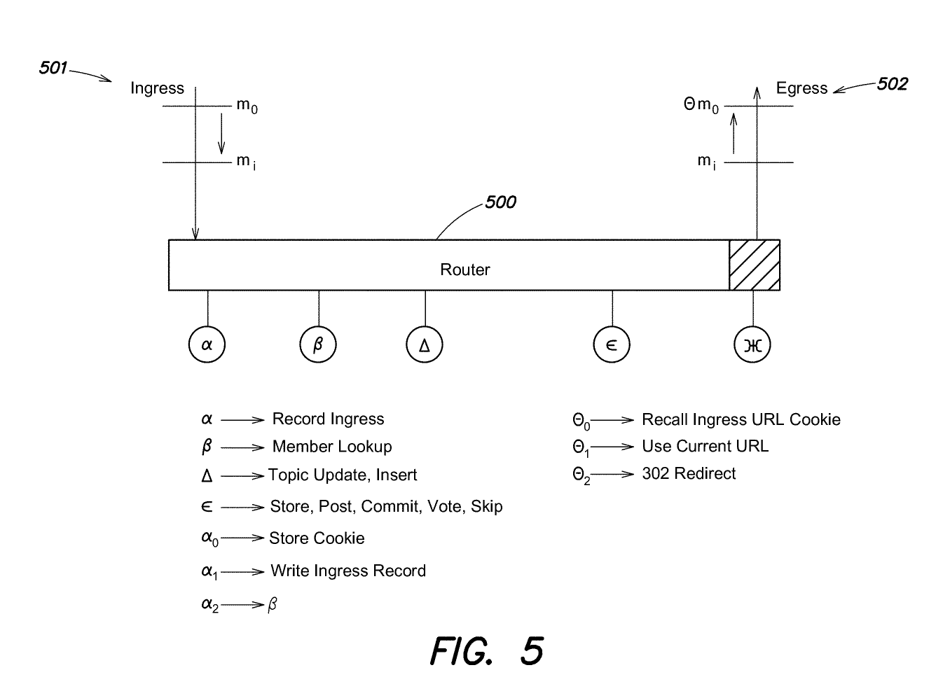

FIG. 5 shows another example implementation of a router component 500 in accordance with various embodiments of the present invention. As discussed above with reference to FIG. 3, a router component may be provided that transitions users from one state of the survey to another. Similar to the system discussed above with reference to FIG. 3, the router 500, may handle interface changes within a survey interface for a particular user from an ingress point (e.g., ingress 501) to an egress point (e.g., egress 502).

According to one implementation, a session-based method may be used to establish connections with the router, and create, track, and store session data using the router. For instance, the well-known Ruby on Rails framework may be used to implement sessions within the router. In one embodiment, an ingress request (e.g., an HTTP request) may be received in handed off to the router via cross process communication. In one embodiment, a domain cookie may be set to record a URL from which the process ingresses into the router. At point α, the router may record information relating to the ingress to a database. For example, at α₀, the router may store a cookie (e.g., in a browser) associated with a user. At α₁, the router may write an ingress record, and at α₂, the router may transition to point β.

At point β, one or more remote lookups may be performed. For instance, a member database lookup may be performed that identifies the user within an external membership database (e.g., a social networking database). At point Δ, a topic update and/or insert may be performed within the database. At point ε, the router may perform a store, a post, a commit, a vote, or a skip action responsive to one or more parameters. At point θ, the system may transition to an egress state with one or more events θ, such as θ₀ which returns the user to the URL identified by the ingress cookie, θ₁ which returns the current URL, and θ₂ which returns an HTTP 302 redirect. It should be appreciated that other implementations of a router component is possible.

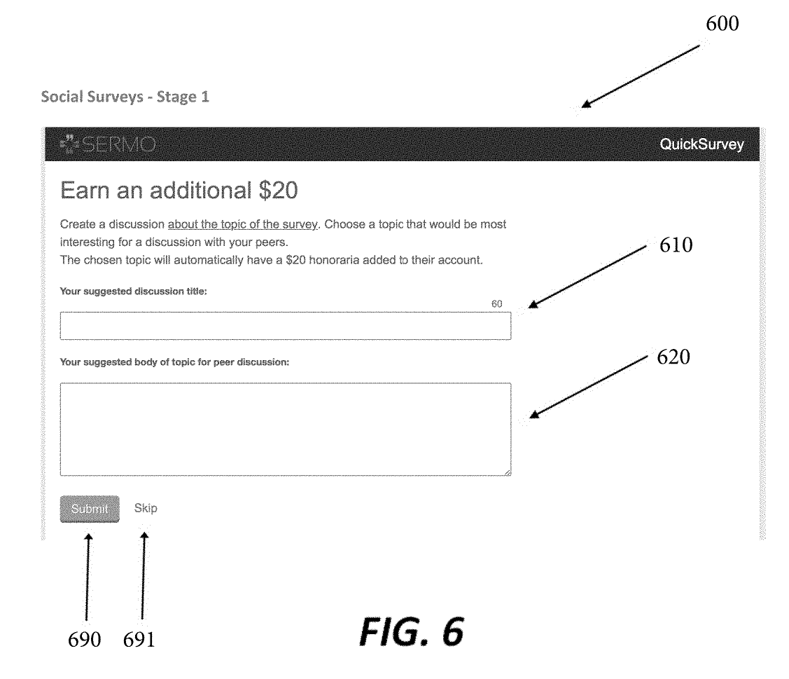

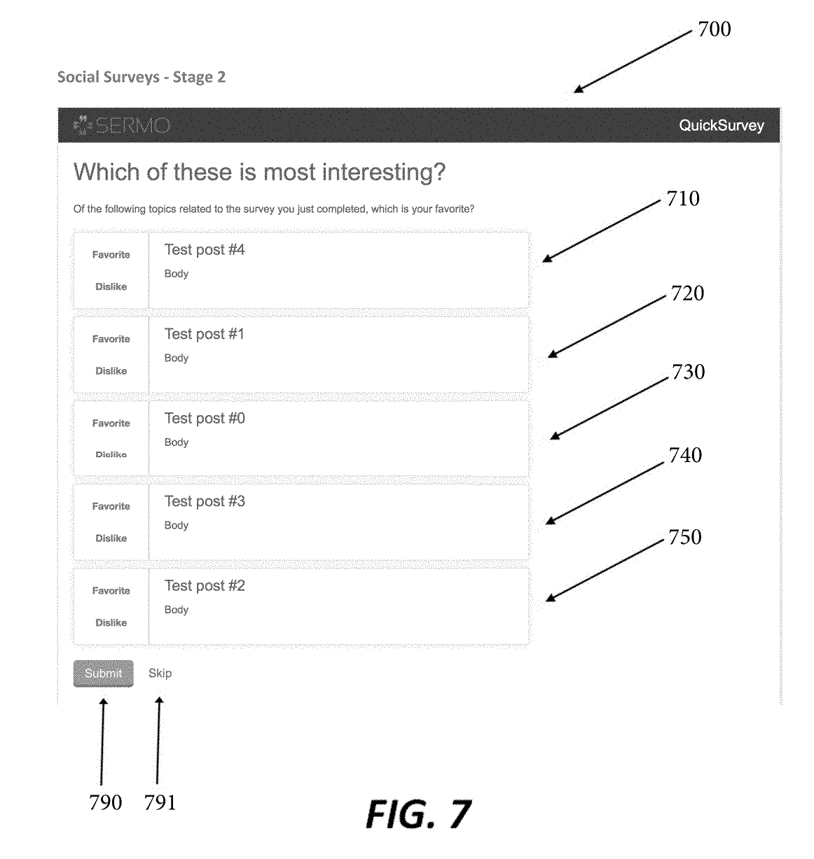

FIG. 6 shows an example user interface of a first stage of a survey function generated by a survey engine. In some embodiments, the survey engine may present a user interface 600 to a user at the first stage of the survey function. At the first stage, the user interface 600 may allow the user to submit a topic of discussion for the user and the user's peers to discuss. For example, the user interface 600 may comprise a first input field 610 in which the user may provide a title of the topic of discussion. The user interface 600 may comprise a second input field 620 in which the user may provide more information, or a body, for the topic of discussion. The user interface may include a submit button 690 and a skip button 691. The user may press the submit button 690 to submit a discussion topic by providing input to the first input field 710 and the second input field 720. The user may press the skip button 691 to elect to not provide a discussion topic. In some embodiments, the user may receive a reward for submitting a discussion topic, which will be described in further detail in connection with FIG. 7. After one or more users have submitted discussion topics at the first phase of the survey function, a second phase of the survey function may begin. In some embodiments, the second stage of the survey function may not begin if not enough discussion topics have been submitted. For example, the survey engine may determine a value P, representing a threshold of submitted discussion topics. For example, the threshold of submitted discussion topics P may be 4. If the number of submitted discussion topics at the first stage of the survey function is less than P, the survey engine may not begin the second stage of the survey function. If the number of submitted discussion topics at the first stage of the survey function is greater than or equal to P, the survey engine may begin the second stage of the survey function.

FIG. 7 shows an example user interface of the second stage of the survey function generated by the survey engine. In some embodiments, the survey engine may present user interface 700 to the user at the second stage of the survey function. At the second stage, the user interface 700 may allow the user to vote on topics of discussion submitted by the user and the user's peers at the first phase of the survey function. The user interface 700 may display multiple (e.g., five) discussion topics for the user to vote on, for example a first discussion topic 710 (Test post #4), a second discussion topic 720 (Test post #1), a third discussion topic 730 (Test post #0), a fourth discussion topic 740 (Test post #3), and a fifth discussion topic 750 (Test post #2). Each of the discussion topics may include buttons allowing the user to “favorite” and “dislike” discussion topics. The user interface may include a submit button 790 and a skip button 791. The user may press the submit button 790 to submit votes if the user has voted (e.g., pressed the “favorite” or “dislike” button(s)) on one or more discussion topics. The user may press the skip button 791 to elect to not submit votes if the user did not vote on any of the discussion topics. After one or more users have submitted votes on the one or more discussion topics at the second phase of the survey function, a third phase of the survey function may begin. In some embodiments, the third stage of the survey function may not begin if not enough votes have been submitted on the one or more discussion topics. For example, the survey engine may determine a value V representing a threshold number of “favorite” votes. For example, the threshold number of “favorite” votes may be 3. If none of the discussion topics have a number of “favorite” votes greater than or equal to V, the survey engine may not begin the third stage of the survey function. However, if at least one of the discussion topics have a number of “favorite” votes greater than V, the survey engine may begin the third stage of the survey function. In some embodiments, the discussion topic(s) that receive a number of “favorite” votes greater than V may be one or more selected topics that are passed to the third stage of the survey function. In some embodiments, one or more users that submitted the one or more selected topics may be rewarded for having their discussion topics selected. For example, the one or more users that submitted the one or more selected topics may receive compensation (e.g., $20).

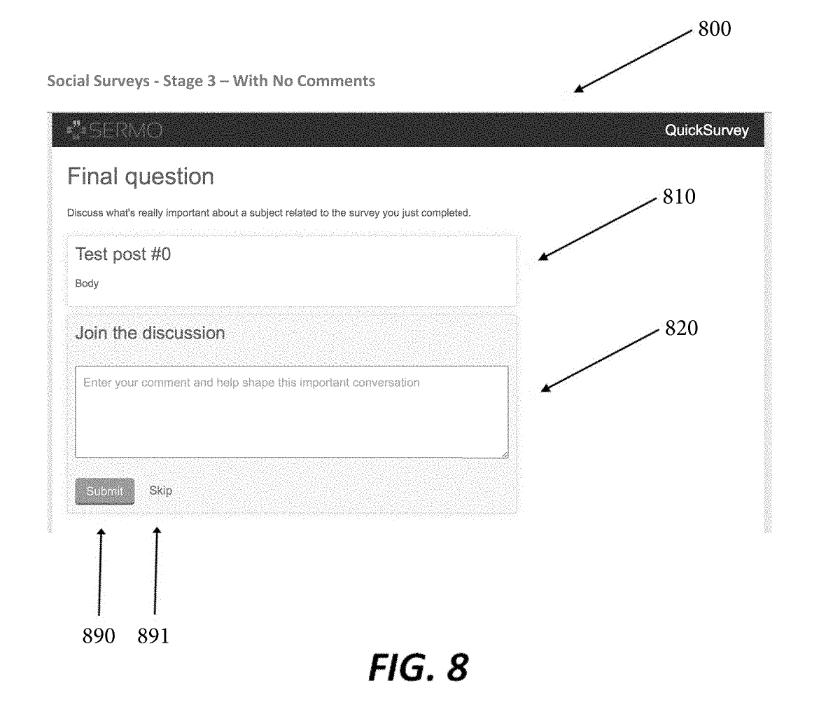

FIG. 8 shows an example user interface of the third stage of the survey function generated by the survey engine. In some embodiments, the survey engine may present user interface 800 to the user at the third stage of the survey function. At the third stage, the user interface 800 may display to the user the one or more selected topics. For example, the user interface 800 may display a selected discussion topic 810 (Test post #0) that received a number of “favorite” votes greater than V at the second stage of the survey function. The user interface 800 may comprise an input field 820 in which the user may provide a comment relating to the selected discussion topic. In this way, the survey engine may be adapted to collect feedback relating to the selected discussion topic. The user interface may include a submit button 890 and a skip button 891. The user may press the submit button 890 to submit a comment that the user provided in input field 820. The user may press the skip button 891 if the user elected not to provide a comment in input field 820.

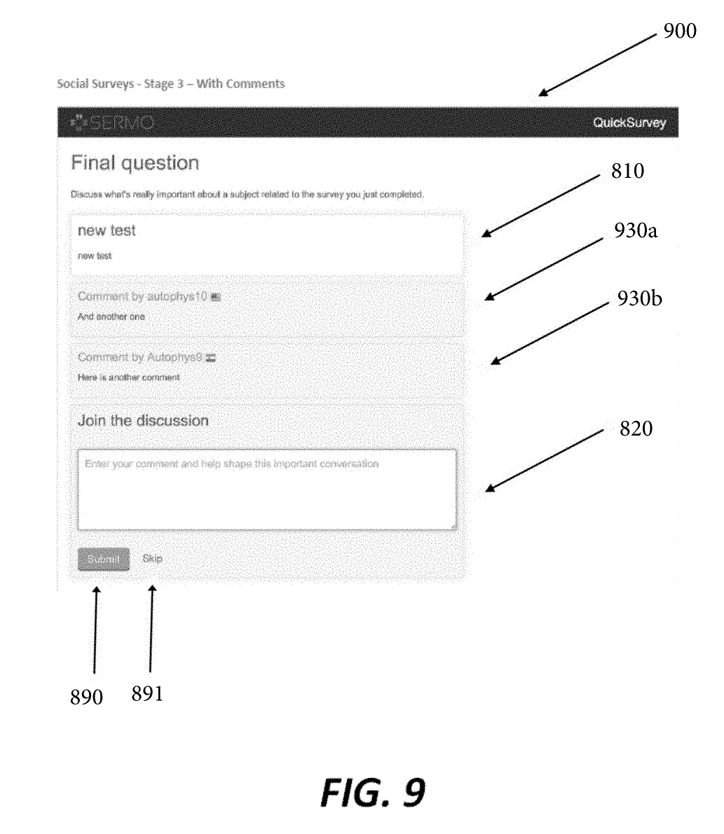

FIG. 9 shows another example user interface of a third stage of the survey function generated by the survey engine. User interface 900 may be largely the same as user interface 800, except that user interface 900 additionally displays comments that have already been submitted. For example, the user interface 900 may display a first comment 930a (Comment by autophys10) and a second comment 930b (Comment by autophys9). In this way, the survey engine may be adapted to automatically display collected feedback relating to the selected discussion topic.

As described, the survey engine may be adapted to generate each stage of the survey function and transition between each stage without operator intervention.

In some embodiments, the first, second, third, and fourth stages of the survey function as described may be a first round of the survey function. In some embodiments, the survey engine may generate multiple rounds of the survey function. For example, the survey engine may generate a second round of the survey function if the one or more selected discussion topics of the first round of the survey function receives a threshold number of comments Cₘ. For example, the threshold number of comments Cₘ may be 30. In such an example, if the one or more selected discussion topics in the first round of the survey function receive at least 30 comments, the survey engine may automatically generate a second round of the survey function. In another embodiment, the survey engine may generate a second round of the survey function if it is predicted that the second round of the survey function may receive a threshold number of predicted comments Cₙ. For example, the threshold number of predicted comments may be 20. Additionally, the survey engine may generate a second round of the survey function if the following is true:

RemainingRespondents>=β₀+Cₙ/β₁,

where RemainingRespondents is the number of respondents remaining from the first round of the survey function, β₀ is a number of respondents needed to proceed from the second stage of the survey function to the third stage of the survey function, Cₙ is the threshold number of predicted comments needed to generate a new round of the survey function, and β₁ is a comment conversion rate, or the number of comments expected to be received from each respondent.

The phraseology and terminology used herein is for the purpose of description and should not be regarded as limiting. Any references to embodiments or elements or acts of the systems and methods herein referred to in the singular may also embrace embodiments including a plurality of these elements, and any references in plural to any embodiment or element or act herein may also embrace embodiments including only a single element. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. Any references to front and back, left and right, top and bottom, upper and lower, and vertical and horizontal are intended for convenience of description, not to limit the present systems and methods or their components to any one positional or spatial orientation.

Having described above several aspects associated with at least one embodiment, it is to be appreciated various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only.

What is claimed is:

1. A distributed system comprising:
at least one hardware processor; and
at least one non-transitory computer-readable storage medium storing processor-executable instructions that, when executed by the at least one hardware processor, cause the at least one hardware processor to perform:
generating a plurality of first stage interfaces, each of the plurality of first stage interfaces being generated for respective ones of a plurality of respondents;
receiving, via the plurality of first stage interfaces, respective topics from one or more of the respondents, each of the respective topics being authored by the respective respondent;
generating a plurality of second stage interfaces, each of the plurality of second stage interfaces being generated for respective ones of the plurality of respondents;
receiving, via the plurality of second stage interfaces, a respective vote for one or more of the received topics;
automatically determining, responsive to the received plurality of votes, at least one winning question of the respective topics received from the respective respondents; and
generating a plurality of third stage interfaces, each of the plurality of third stage interfaces being associated with the plurality of respondents and having controls to accept user feedback regarding the at least one winning topic of the respective topics received from the respective respondents.

2. The distributed system according to claim 1, and wherein the processor-executable instructions further cause the at least one hardware processor to perform:
indicating, to the plurality of respondents, the at least one winning topic responsive to the determining of the at least one winning topic.

3. The distributed system according to claim 1, wherein the processor-executable instructions further cause the at least one hardware processor to perform:
automatically compiling the received user feedback into compiled information and display the compiled information to a client via a fourth stage interface.

4. The distributed system according to claim 3, wherein the processor-executable instructions further cause the at least one hardware processor to perform:
submitting the compiled information as a post to a social network.

5. The distributed system according to claim 4, wherein the processor-executable instructions further cause the at least one hardware processor to perform:
collecting feedback received from the social network relating to the post, and providing the feedback automatically to the client.

6. The distributed system according to claim 1, wherein the processor-executable instructions comprise a router component that causes the at least one hardware processor to perform:
transitioning a respondent through a set of first, second and third stage interfaces.

7. The distributed system according to claim 6, wherein the router component causes the at least one hardware processor to perform:
validating a user token associated with a respondent.

8. The distributed system according to claim 6, wherein the router component causes the at least one hardware processor to perform:
checking of a particular project survey prior to admittance of the user to the project survey.

9. The distributed system according to claim 6, wherein the router component causes the at least one hardware processor to perform:
checking of a particular member prior to admittance of the user to a project survey.

10. The distributed system according to claim 6, wherein the router component causes the at least one hardware processor to perform:
checking of a particular member and project combination prior to admittance of the user to a project survey.

11. The distributed system according to claim 6, wherein the router component causes the at least one hardware processor to perform:
transitioning a respondent to a particular survey based on one or more parameters relating to a user.

12. The distributed system according to claim 6, wherein the router component causes the at least one hardware processor to perform:
evaluating one or more parameters relating to a state of a survey; and
executing a transition between the set of first, second and third stage interfaces responsive to the evaluation of the one or more parameters.

13. The distributed system according to claim 12, wherein the evaluation and transition is performed in real time in parallel for a plurality of surveys.

14. The distributed system according to claim 6, wherein the router component causes the at least one hardware processor to perform:
evaluating a member and/or a project responsive to logic defining whether to admit a user to a specified survey.

15. The distributed system according to claim 6, wherein the router component causes the at least one hardware processor to perform:
transitioning the user to an egress state of a browser program.

16. The distributed system according to claim 6, wherein the router component causes the at least one hardware processor to perform:
recording a plurality of ingress and egress states associated with a particular user and project.

17. The distributed system according to claim 1, wherein the processor-executable instructions further cause the at least one hardware processor to perform:
permitting an anonymous bidirectional communication between a client that sponsors the survey and at least one of the plurality of respondents.

18. The distributed system according to claim 17, wherein the processor-executable instructions further cause the at least one hardware processor to perform:
awarding an honorarium to the at least one of the plurality of respondents for opting into the bidirectional communication.

19. The distributed system according to claim 1, wherein the processor-executable instructions further cause the at least one hardware processor to perform:
generating a client interface in which a client is permitted to submit a seed topic to which the respective topics are submitted from one or more of the respondents.

20. The distributed system according to claim 19, wherein the processor-executable instructions further cause the at least one hardware processor to perform:
generating an input within the client interface that permits the client to submit a winning topic, and responsive to the submission of the winning topic, bypassing the first stage and second stage receiving stages.
